(19) United States
(12) Patent Application Publication
(10) Pub. No.: US 2014/0342337 A1
(43) Pub. Date: Nov. 20, 2014

(54) PERVASIVE TRAINING OVER DIFFERENT LOCATIONS OR DEVICES AS A FUNCTION OF PRESENCE

(71) Applicant: International Business Machines Corporation, Armonk, NY (US)

(72) Inventors: Scott G. Bowden, Mableton, GA (US); Christopher J. Dawson, Arlington, VA (US); Sanjeev Kumar V. Marimekala, Naugatuck, CT (US)

(73) Assignee: International Business Machines Corporation, Armonk, NY (US)

(21) Appl. No.: 13/893,563

(22) Filed: May 14, 2013

(51) Int. Cl. G09B 5/12; G09B 5/06

(52) U.S. Cl. CPC G09B 5/125; G09B 5/065
USPC 434/314

(57) ABSTRACT

Audio-video components present different queries associated with different unlearned portions of stored training information to a trainee in response to detecting presences of the trainee at different, respective geographic locations that are each within a specified spatial proximity to the first audio-video components. The specified spatial proximity is selected so that text messages of the queries displayed in a specified font size on a display device of the audio-video components are legible, or that spoken words of the first or second query conveyed within audio media on a speaker are sufficiently loud to be heard by the trainee, or that an earpiece worn by the trainee establishes a wireless communication with the audio-video components to convey the spoken words of the queries within the audio media.

### FIELD OF THE INVENTION

The present invention relates to training methods and systems that use audio and visual media to teach material to subjects in response to proficiency testing feedbacks.

### BACKGROUND

Training programs and techniques include classroom models wherein a live, human instructor directly leads training. This is often the most effective type of training, though it is the most costly as well, both in terms of facilities and resources. Instructor-led or self-paced online training models are less costly than classroom learning, but results may be less effective than those obtained from in-person sessions. Both classroom and online training can suffer from attention span issues, as well as distractions caused by trainee multi-tasking during training sessions.

The episodic nature of conventional training interactions also presents challenges to effective learning. More particularly, training may occur in one or several sessions (episodes), wherein the trainee usually attends a course or completes an online training session, optionally takes a test, and then moves on to the next course or training session without necessarily absorbing or learning the conveyed information. If a required amount of the conveyed information is not satisfactorily learned by the trainee, for example, and indicated by a failure to pass a comprehensive standardized test, then the trainee is generally required to repeat an entirety of a course of multiple sessions.

Administrating and executing conventional training sessions often incurs direct and indirect costs. For example, corporate training sessions generally require employees to allocate time away from productive work day schedules, or impose additional demands on time otherwise allocated for other tasks within the scope of organizational responsibilities.

### BRIEF SUMMARY

In one aspect of the present invention, a method for pervasive training across multiple devices or locations. The method comprehends presenting to a trainee via a first audio-video component a first query that is associated with a first unlearned portion of different stored portions of training information, in response to detecting a presence of the trainee at a first geographic location that is within a specified spatial proximity to the first audio-video component. In response to detecting a presence of the trainee at a second, different geographic location within the specified spatial proximity to the first audio-video component or a second audio-video component, a second query is presented to the trainee via one of the first and second audio-video components within the specified spatial proximity, wherein the second query is associated with a different stored portion of training information. In one aspect, the specified spatial proximity is selected so that text messages of the queries displayed in a specified font size on a display device of the first or second audio-video components are legible to the trainee while within the specified spatial proximity to the display device. In another aspect, the specified spatial proximity is selected so that a speaker of the first or second audio-video components is near enough to the trainee to convey spoken words of the first or second query within audio media at an audio volume sufficiently loud to be heard and understood by the trainee. In another aspect, the specified spatial proximity is selected so that an earpiece worn by the trainee establishes a wireless communication with the first or second audio-video components to convey the spoken words of the queries within the audio media.

In another aspect, a system has a processing unit, computer readable memory and a tangible computer-readable storage medium with program instructions, wherein the processing unit, when executing the stored program instructions, presents to a trainee via a first audio-video component a first query that is associated with a first unlearned portion of different stored portions of training information, in response to detecting a presence of the trainee at a first geographic location that is within a specified spatial proximity to the first audio-video component. In response to detecting a presence of the trainee at a second, different geographic location within the specified spatial proximity to the first audio-video component or a second audio-video component, a second query is presented to the trainee via one of the first and second audio-video components within the specified spatial proximity, wherein the second query is associated with a different stored portion of training information. In one aspect, the specified spatial proximity is selected so that text messages of the first or second queries displayed in a specified font size on a display device of the first or second audio-video components are legible to the trainee while within the specified spatial proximity to the display device. In another aspect, the specified spatial proximity is selected so that a speaker of the first or second audio-video components is near enough to the trainee to convey spoken words of the first or second query within audio media at an audio volume sufficiently loud to be heard and understood by the trainee. In another aspect, the specified spatial proximity is selected so that an earpiece worn by the trainee establishes a wireless communication with the first or second audio-video component to convey the spoken words of the queries within the audio media.

In another aspect, a computer program product for pervasive training across multiple devices or locations has a tangible computer-readable storage medium with computer readable program code embodied therewith, the computer readable program code comprising instructions that, when executed by a computer processing unit, cause the computer processing unit to present to a trainee via a first audio-video component a first query that is associated with a first unlearned portion of different stored portions of training information, in response to detecting a presence of the trainee at a first geographic location that is within a specified spatial proximity to the first audio-video component. In response to detecting a presence of the trainee at a second, different geographic location within the specified spatial proximity to the first audio-video component or a second audio-video component, a second query is presented to the trainee via one of the first and second audio-video components within the specified spatial proximity, wherein the second query is associated with a different stored portion of training information. In one aspect, the specified spatial proximity is selected so that text messages of the first or second queries displayed in a specified font size on a display device of the first or second audio-video components are legible to the trainee while within the specified spatial proximity to the display device. In another aspect, the specified spatial proximity is selected so that a speaker of the first or second audio-video components is near enough to the trainee to convey spoken words of the first or second query within audio media at an audio volume sufficiently loud to be heard and understood by the trainee. In another aspect, the specified spatial proximity is selected so that an earpiece worn by the trainee establishes a wireless communication with the first or second audio-video component to convey the spoken words of the queries within the audio media.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a flow chart illustration of a method, system or process according to the present invention for pervasive training across multiple devices or locations.

FIG. 2 is a flow chart illustration of another aspect of a method, system or process according to the present invention for pervasive training across multiple devices or locations.

FIG. 3 is a block diagram illustration of a computer system implementation of an aspect of the present invention.

The drawings are not necessarily to scale. The drawings are merely schematic representations, not intended to portray specific parameters of the invention. The drawings are intended to depict only typical aspects, examples and embodiments of the invention, and therefore should not be considered as limiting the scope of the invention. In the drawings, like numbering represents like elements.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium excludes transitory, propagation or carrier wave signals or subject matter and includes an electronic, magnetic, optical or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that does not propagate but can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic or optical forms or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

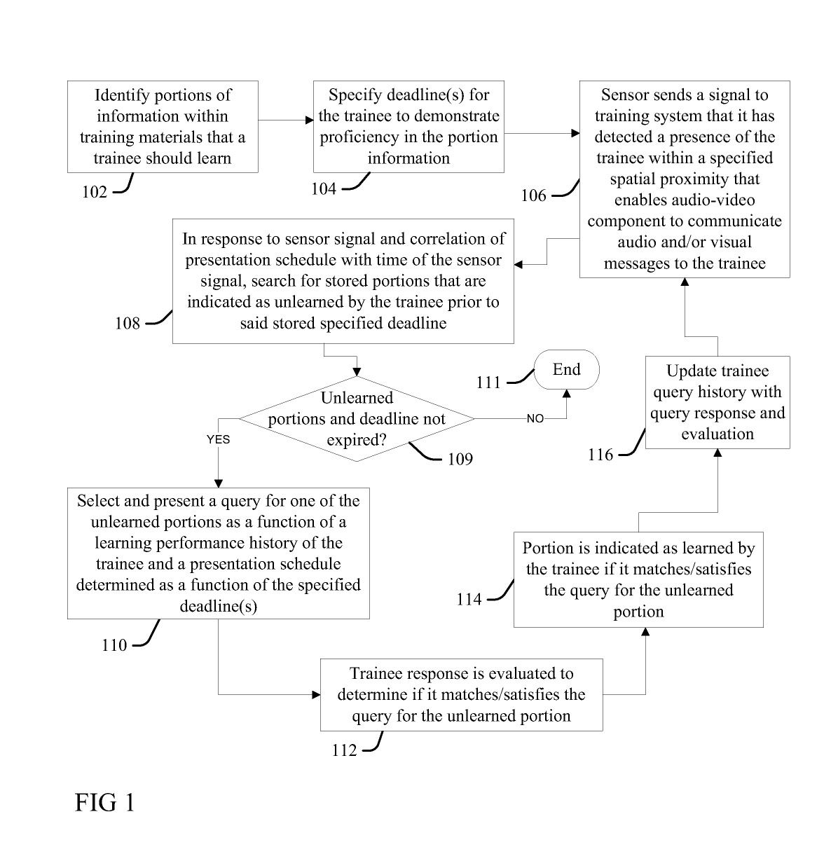

FIG. 1 illustrates a method, system or process for pervasive training across multiple devices or locations according to the present invention. At 102 an instructor, training administrator or other entity identifies portions or subsets of information within training materials that a trainee should learn, in some examples in a greater detail or level of comprehension relative to other portions of the training materials. In order to enhance the benefits of repetitive learning, aspects of the present invention generate the portions to be relatively small, and able to be absorbed rapidly in one session by a trainee. For example, a lesson module on a given subject may be broken down into portions that each represents one concept that is likely or known to be subject to a test question on a standardized test, or one important attribute of a product.

At 104 one or more deadlines are specified by which the trainee should demonstrate proficiency in the portion information, that he or she has learned the material. Deadlines include an upcoming client meeting where a salesperson would want to have memorized the specifications of a new product, or an exam date for a standardized test, and other examples will be apparent to one skilled in the art.

At 106 a sensor in communication with a training system sends a signal to the training system that it has detected a presence of the trainee at a specific geographic location within a specified spatial proximity to an audio-video component that is also in communication with the training system. The specified spatial proximity is selected to enable the audio-video component to communicate aural and video messages to the trainee on a video display of the audio-video component. More particularly, the proximity is near enough to the display that a display of text messages in a specified font size would be legible to the trainee; that audio media may be conveyed by a speaker of the audio-video component that is near enough to the trainee so that spoken words within the audio media may be heard and understood by the trainee; or that a personal headphone or earpiece worn by the trainee establishes a wireless communication with a source of audio media for replication on the headphone or earpiece, such as the audio-video component or other network device. The trainee, sensor or the audio-video component need not be located in a designated classroom or training area, but may be located anywhere that the trainee is anticipated to be found, including at various locations within home and workplace areas.

The sensor may be a Radio Frequency Identification (RFID) sensor or scanner that detects and communicates with an RFID chip in a trainee badge or other unique item carried or worn by the trainee and thereby determines a presence of the trainee within the specified proximity to the audio-video device. Other examples of automated processes for determining or confirming the spatial location of the trainee as within the specified proximity include Bluetooth® sensors or communication components that communicate with Bluetooth® devices carried or worn by the trainee and enabled to receive unique indicia there from, and optionally to communicate media data to the trainee's Bluetooth® device; visual scanners and cameras that use facial recognition technique to sense and distinguish the trainee from other people and faces; Global Positioning Satellite (GPS) components and devices; cellular triangulation techniques; physical trip wires; manually operated components and signal inputs, such as the trainee pressing a button as the trainee passes a system display/speaker that can visually and/or audibly display queries and other media; and still other sensors and trainee identification techniques will be apparent to one skilled in the art. (BLUETOOTH is a registered trademark of Bluetooth SIG, Inc. in the United States or other countries.)

The training system is also in communication with a storage device, server, etc., that has the portions identified at 102 and deadline specified at 104 stored thereon. Thus, in response to said sensor signal at 106, and to a correlation of presentation schedule with clock signal or other time indication of a current time of the sensor signal, at 108 the training system searches for one or more of the stored portions that are indicated as not learned (unlearned) by the trainee prior to said stored specified deadline.

If said search finds a stored portion that is indicated as not learned by the trainee prior to said stored specified deadline, and the specified deadline(s) have not expired, the process flows through at 109, and at 110 the training system and selects and present a query for one of the unlearned portions as a function of a learning performance history of the trainee and a presentation schedule determined as a function of the specified deadline(s). Presentation of the query for the portion is an audio, video or audio/video presentation via an audio-video display device that is within the specified proximity of the trainee at the ascertained time of the signal (in effect, the trainee is located proximate to the device at the time of the signal). Thus, audio playback could occur via headphones connected to an employee's smart phone or wirelessly in communication with the training system.

Visual and/or audio presentation of portion training material may occur on an employee's computer, smart phone, or on flat screen displays positioned throughout home or workplaces in areas where the trainee is known or expected to occupy, or where trainees sharing common identity indicia tend to congregate, such as by elevators, outside conference rooms, or in break rooms, kitchens, gymnasiums and work-out spaces, employee nursery areas, coffee kiosk queues, etc., playback may be used by employees waiting in a line at a coffee shop, and still other suitable communications will be apparent to one skilled in the art. In other aspects, the query is presented at 110 on a trainee's laptop or via a voice recognition Interactive Voice Response (IVR) application that places an outbound call to the employee and tests the employee's knowledge of the training material.

The portion query at 110 prompts the user to enter a response via an input device in communication with the training system. Examples of the input device include a keypad or keyboard that receives text string inputs from the trainee, a microphone that receives spoken words which are recognized and encoded into text string replies by a speech analysis or voice response engine; selectable radio buttons associated with each of different multiple choice or yes/no or true/false answers; and still other suitable input devices will be apparent to one skilled in the art. The input device may be attached to or associated with the query presenting device (for example, a touch keypad on a digital display screen), wherein the trainee may immediately enter a response. Alternatively, the input device may be a different device located remotely from the query presentation device, and wherein the response may be entered at some subsequent time. For example, the query may be displayed to the trainee on a display next to an elevator door while the trainee awaits arrival of the elevator, and the input device may be a keyboard of a computer operated by the trainee back at a workstation, or of another device at home, wherein the response is provided when the trainee returns to said workstation or home.

The trainee response is evaluated at 112 by the training system to determine if it matches or otherwise satisfies the portion associated with the query. If so, then at 114 said portion is indicated as learned by the trainee (and thereby will not satisfy searches for unlearned portions at further iterations of the step at 108). A trainee query history for the trainee is updated at 116 with the query response and the evaluation thereof. The process then loops back to 106 to repeat, until at 109 either all portions are learned or the deadline expires, wherein the process ends at 111.

Thus, subsequent to the steps described above, in a second iteration the sensor signal at 106 is generated in response to detecting a presence of the trainee at a second geographic location that is different from the first geographic location and also within the specified spatial proximity to the first audio-video component, or to a second audio-video component at that second location. In response, the training system again searches for unlearned portions at 108, and presents a query associated with a retrieved unlearned portion at 110 to the trainee, via either of the first or second audio-video components within the specified spatial proximity at the different, second geographic location.

It is noted that if the evaluated response to the query presented at the first location satisfies the unlearned portion at 112, said portion is marked as learned at 114 and will therefore not be returned as a result in the search for unlearned portions in the subsequent step at 108 for the second, different location. Therefore, in this situation the selection of an unlearned portion via the query steps at the second location excludes the portion selected and used in the earlier iteration of step 108 at the first geographic location: this portion is no longer marked or indicated as “unlearned”, but is now “learned” and excluded for possible results to a search for unlearned portions.

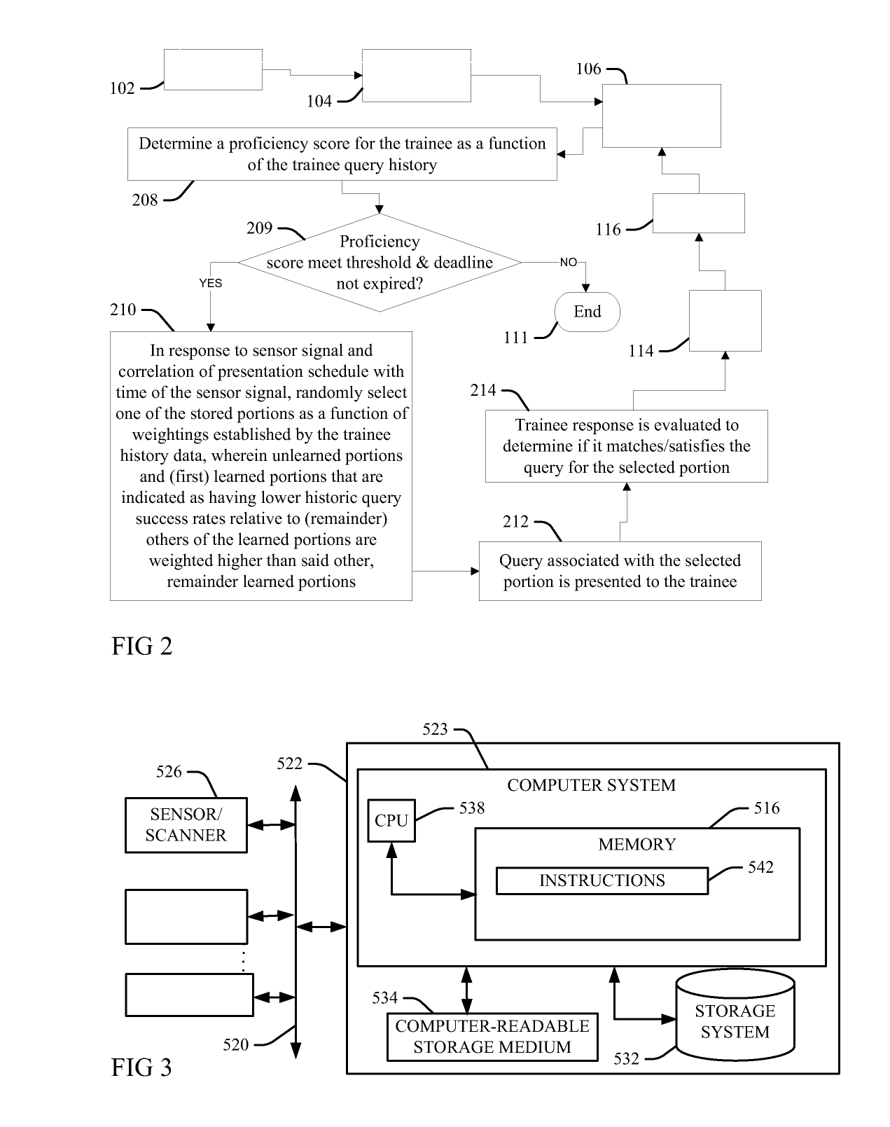

The aspect described thus far with respect to FIG. 1 provides a training feedback process that incorporates a feedback loop to iteratively test the trainee on each unlearned portion in response to each sensor signal to determine when he or she has learned the presented information. FIG. 2 illustrates another aspect that continues to select and present queries with respect to satisfied, learned portions as well, for example to reinforce the proficiency of the trainee on such portions through repetition. More particularly, the selection of portions and queries in the aspect of FIG. 2 is based on demonstrated proficiencies of the trainee rather than the determination of unlearned portions alone. Thus, in response to the sensor signal as described above at 106 of FIG. 1 (and optionally to a clock signal), at 208 the training system determines a proficiency score for the trainee as a function of the trainee query history, for example a success rate percentage over all query replies, or specific to queries related to certain portions that are specified as benchmark portions. If at 209 the proficiency score meets a specified proficiency threshold (for example, 70%, 80%, 90% or 95%, etc.) or a relevant specified deadline has expired, the process ends at 111.

Otherwise, at 210, in response to the sensor signal and a correlation of a presentation schedule with time of the sensor signal, the training system randomly selects one of the stored portions as a function of weightings established by the trainee history data, wherein unlearned portions and (first) learned portions that are indicated as having lower historic query success rates relative to (remainder) others of the learned portions are weighted higher than said other, remainder learned portions that do not have the lower historic query success rates. At 212 a query associated with the selected portion is presented to the trainee. As discussed above with respect to 110 of FIG. 1, presentation of the query includes an audio, video or audio/video presentation via an audio-video display or headphone or speaker on an employee's computer, smart phone, flat screen display, etc., that may occur throughout home or workplace areas where the trainee is known or expected to occupy.

At 214 the trainee's response to the presented query (via input devices including keypads, keyboards, microphones, etc., as discussed above with respect to 112 of FIG. 1) is evaluated to determine if it matches/satisfies the query for the selected portion. The results of said evaluation are then used to indicate if an unlearned portion is now learned at 114, and to update the trainee history at 116, as discussed above with respect to FIG. 1.

In some aspects, sensor signal inputs are polled at 106 at pre-defined intervals or other time periods selected to instigate query generations and presentations according to a presentation schedule that specifies when and how many times or how frequently the trainee employee should see queries on the respective portion information before being tested. For example, the trainee may set the schedule to generate queries when proximate to a display device outside of working hours, such as in the morning while preparing for work at home and commuting to work, during lunch periods, or in the evening after the work day. Alternatively, the training may be restricted to specified working hours or other specific time periods during the day. Thus, while during designated training periods the training system receives sensor signals and causes presentation of queries in a variety of different locations (in rooms at home, on screens near elevator doors in building lobbies, on smart phones and through headphones, etc.), extending training beyond single, fixed locations and devices into a wide variety of forums and via a wide variety of media transmitters. Training is driven by schedule and materials to be conveyed, and independent of any specific location that the trainee may be located within.

The sensor signal at 106 and presentation decisions made at 110 and 210 may be driven by a clock or other timer, which may be useful if the audio-video device is a smart phone carried by the trainee and therefore usually within the specified proximity. Since a smart phone may be generally within the specific proximity of the trainee at all times, the mere presence of the trainee within the specified proximity will not be useful in serving as an instigating event for selecting and generating a query, otherwise the trainee will be continuously prompted with queries at 110. The location of the trainee within the proximity at 106 may be useful to confirm that the trainee is near enough to an audio chime or other signal to alert the trainee that he or she should refer to the smart phone to see or hear a presentation of the query at 110 or 210 on a specific presentation schedule.

Evaluation of the response at 112 may include logging a success at 114 and immediately moving on to a next learning item for another, subsequent selection and display or presentation at 108/110 or 210/212. A failure of the response to satisfy the query is also logged at 116 and may be used to both keep the associated portion information in rotation for subsequent queries, and for adjusting the amount of time an item is displayed or presented aurally as needed (for example, a future query generated for the same portion may be simplified, or displayed for a longer time).

Progression through the portions in subsequent iterations may be in a non-serial or non-ordered manner, for example depending on learning preferences indicated by the trainee or administrator wherein certain portions may have higher weighting and are therefore more likely to be selected in each iteration.

The response history created, updated or maintained training system at 116 tracks the results and evaluations of each learning experience response at 114 for the trainee over time, and in some aspects also for pluralities of trainees. This data may be used in the training system to adjust repetition and presentation methods to select queries or portions that work best with each trainee, or that work best across pluralities of trainees. For example, the tracked response history might indicate that a first trainee learns best from audio interactions (has a higher success rate relative to visual text presentations), and accordingly the training system will favor (bias toward or more favorably weight) audio queries at 110 or 210 over text queries as a better way to get information to the trainee, while a second trainee may demonstrate better results from visual text query presentations, and in response to the bias or weighting will be adjusted at 116 to favor the selection of visual text query presentations at 110 or 210 over audio queries for the second trainee.

The training system may incorporate trend analytics processes to also look across the trainee population as a whole and identify patterns of successful and unsuccessful learning, such as the amount of time an item is displayed or how much time has elapsed between interactions. Aspects of the training system may also analyze how other employees fare with learning different materials in updating the history data at 116, and responsively adjust learning plans and repetition strategies used to select the portions and queries at 110 or 210 based on average performances. Average results or trends indicating one method or content of presentation is better than another for groups of trainees and may be used to weight or favor such content or presentations for all trainees over other query content options during the selection and presentation steps at 108/110 or 210/212.

In response to the response histories as updated at 116 indicating that some or many trainees tend to struggle with a certain piece of portion material, the training system may adjust how that material is presented in the future for all employees. In one example, the history as updated at 116 shows that multiple query iterations are generally necessary before the trainees successfully answer one or more queries drawn to information of one of the portions. Accordingly, while indicated as unlearned, this portion is weighted or favored over other unlearned portions in the search at 108 and selection and presentment at 110 or 210, in order that more iterations of query presentment occur for this one portion at 110 or 210 over time than for the other unlearned portions, or that they occur at a higher frequency, when the process loops and repeats until all unlearned portions test out/are evaluated as learned at 114.

The training system may also calculate how quickly the trainee is advancing towards learning all of required portion materials by the pre-defined deadline and speed up or slow down the interactions accordingly based on that timeline. For example, if the trainee is demonstrating an overall proficiency in correctly responding to a threshold number, or at a threshold frequency, of queries as determined at 114 (for example, 80%, 90%, or 95%, etc.), then the frequency of query presentations at 110 may be increased, or multiple queries may be presented at each iteration at 110. If the trainee is demonstrating poor proficiency in correctly responding to some other threshold number of queries (for example, less than a 70% success rate in responding to the queries), then the content of the query presentations at 110 may be revised to simplify the query or reduce the amount of information needed to satisfy a query determination within the response evaluation at 114.

In one example, a specified deadline is an exam in two weeks. If an analysis of the trainee history at 110 indicates that not enough query answers are right (for example, less than 70% of all query responses are satisfactory), in view of the approaching deadline the training system ramps up the training, increasing the frequency with which a clock input triggers a polling of sensor data received at 106 to present queries at 110 or 210, for example, to every time the trainee passes a mirror comprising a sensor and display device, in some aspects until the updated history indicates an increasing proficiency. In contrast, if the updated history indicates a satisfactory progress toward learning the portions (for example, over 80% of responses are satisfactory), then the training system may reduce the numbers and frequencies of query displays over the remaining two weeks, for example limiting the query presentments at 110 or 210 when the sensor signals also indicate that the trainee is proximate to one of the display devices (including the one within the minor) to only during certain times of day (such as a designated lunch, break or evening time period). In this fashion, aspects may dynamically reduce the intrusive nature of the querying system in response to satisfactory performances by the trainees, establishing more relaxed schedules for presenting queries that also effectively reduce the frequency or number of queries presented over time. Some aspects may also reduce total queries or frequencies thereof by concentrating on certain ones, categories or types of queries that continue to have low or lower success rates (by this trainee or as indicated by the histories of pluralities of trainees).

Thus, aspects of the present invention provide methods and systems for pervasive training that provide enhanced training through the use of repetitive audio and visual interactions with trainees combined with a reactive system that tests trainees and learns from these interactions, adjusting training patterns based on individual and group outcomes. Aspects use the power of environmental aural and visual repetitive learning to improve training methods, a real-time feedback loop of testing to determine how well this absorption is taking place with reactive learning on the part of the system to adjust its presentation methods to the needs of individual trainees. Aspects provide trainings presentations that are episodic in nature through visual and audio repetition of training materials along with a system to track results. Analytics based on users' experiences in trouble spots of training material may thus be readily identified during repetitive learning and provide guidance and feedback to improve the process with each iteration.

For many trainees, the most effective path to learning is through repetition. For example, a person who repeatedly sees the same picture on a wall, in an area the person frequently visits, will, after a certain number of times, unwittingly absorb that picture and be able to replicate it mentally to great detail. The same is true if the picture on a wall has words on it, such as a catch phrase or a poem. Similarly, a person hearing the same information on multiple occasions may absorb that information effectively and be able to repeat it. Visual and audio repetitions via aspects of the present invention thereby provide enhanced tools for learning.

The training is pervasive and may automatically and intelligently follow the trainee around and track where the trainee is via a plurality of sensor inputs at 106 from different sensors at different times, and thereby determining which of the different sensor and audio-visual display locations are better or best places to present queries at 110. For example, the system may determine that the evaluated responses of a trainee to queries presented in an early morning period on a display embedded within a bathroom mirror display in the home of the trainee have a relatively high rate of success (compared with queries presented at different locations, or at different times on the same display). Accordingly, the training system may select portions weighted the highest for difficulty, or only unlearned portions, for queries displayed within the minor display when the sensor signal indicates (at 106) that the trainee is proximate to the mirror display during said early morning time period. In one aspect, the training system thereby dynamically adapts to the learning style of the trainee as reflected by the updated training history, tracking where the trainee learns well and then focusing the learning (query) method on a one better or best suited to the trainee based on testing results. Portion and query selections may also focus on questions the trainee is consistently getting wrong, and adjust the timing or frequency of query presentments to ramp up intensity as a deadline approaches for mastering the portion content.

Aspects provide for intelligent, pervasive mobile learning by intelligently monitoring the location of the trainee and presenting the training material on the most effective platform at that point in time based on the training plan. Aspects also expand training platforms away from computers and smart phones, etc., that are personal to the trainee to also include non-traditional forms of providing training content to users, such as an LCD display by an elevator which may take advantage of the time a person has to wait by the elevator to provide material to a user based on RFID location identification, or a washroom mirror with an embedded LCD display. Displays by or incorporated into a coffee maker, water cooler, refrigerator or food or drink vending machine may also provide training opportunities in the time it takes the trainee to make coffee or get and consume a drink or snack, finding additional time to present training queries and ascertain the adequacy of responses thereto without requiring the trainee to carve time out of available working hours: break time that is otherwise free and non-productive time is thereby converted into a training opportunity.

The context of the sensor data provided at 106 may also be considered to select the appropriate query presentation at 110 or 210. For example, if the trainee is in a public area likely frequented by other people, such as an elevator lobby, car, mass transit area, etc., then an audio query presentation may be conditional upon detecting that the trainee has headphones deployed and set to privately and personally receive audio query information (via a headphone cord from a smart phone carried by the trainee, or enabled to receive the audio via Bluetooth®, etc.).

Referring now to FIG. 3, an exemplary computerized implementation of an aspect of the present invention includes a computer system or other programmable device 522 in communication 520 with one of sensors or scanners 526 (for example, RFID, Bluetooth®, visual, GPS, cellular triangulation, physical trip wire, and manually operated sensors, scanners, switches, buttons and components, etc.) that are located at known or determined geographic locations. The device 522 selects and presents queries associated with different respective portions of training information in response to detecting the presence of a trainee at different specific geographic locations or times within a specified spatial proximity to an audio-video component used to present said queries to the trainee, as described above with respect to FIGS. 1 and 2. Instructions 542 reside within computer readable code in a computer readable memory 516, or in a computer readable storage system 532, or other tangible computer readable storage medium 534 that is accessed by a Central Processing Unit (CPU) 538 of a computer system or infrastructure 523 of the mobile device 522. Thus, the instructions, when implemented by the processing unit 538, cause the processing unit 538 to automatically retrieve and provide temporary asset 526 identity and precise geographic locations in real-time as described above with respect to FIGS. 1 through 3.

In one aspect, the present invention may also perform process steps of the invention on a subscription, advertising, and/or fee basis. That is, a service provider could offer to integrate computer-readable program code into the computer system 522 to enable the computer system 522 to automatically select and present queries associated with different respective portions of training information in response to detecting a presence of a trainee at different specific geographic locations or times within a specified spatial proximity to an audio-video component used to present said queries to the trainee, as described above with respect to FIGS. 1 and 2. The service provider can create, maintain, and support, etc., a computer infrastructure, such as the computer system 522, network environment 520, or parts thereof, that perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 522, from a tangible computer-readable medium device 532 or 534; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The aspect was chosen and described in order to best explain the principles of the invention and the practical application, and to enable others of ordinary skill in the art to understand the invention for various embodiments with various modifications as are suited to the particular use contemplated.

The flowchart and block diagrams in the figures illustrate the architecture, functionality, and operation of possible implementations of systems, methods and computer program products according to various aspects of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for pervasive training across multiple devices or locations, the method comprising:
in response to detecting a presence of a trainee at a first geographic location that is within a specified spatial proximity to a first audio-video component, presenting to the trainee via the first audio-video component a first query that is associated with a first unlearned portion of a plurality of different stored portions of training information; and
in response to detecting a presence of the trainee at a second geographic location that is different from the first geographic location and within the specified spatial proximity to one of the first audio-video component and a second audio-video component, presenting to the trainee, via the one of the first audio-video component and the second audio-video component that is within the specified spatial proximity a second query that is associated with a second portion of the plurality of different stored portions of training information that is different from the first unlearned portion; and
wherein the specified spatial proximity is selected so that:
text messages displayed in a specified font size on a display device of the one of the first audio-video component and the second audio-video component that is legible to the trainee within the specified spatial proximity to the display device;
a speaker of the one of the first audio-video component and the second audio-video component is near enough to the trainee to convey spoken words within audio media at an audio volume sufficiently loud to be heard and understood by the trainee, or
an earpiece worn by the trainee establishes a wireless communication with the one of the first audio-video component and the second audio-video component to convey the spoken words within the audio media; and
wherein the first query and the second query each comprise at least one of a text message displayed in the specified font size on the display device, and spoken words that are within the audio media.

2. The method of claim 1, further comprising:
integrating computer-readable program code into a programmable device, wherein the programmable device comprises a processing unit, a computer readable memory and a computer readable tangible storage medium, and wherein the computer readable program code is embodied on the computer readable tangible storage medium and comprises instructions that, when executed by the processing unit via the computer readable memory, cause the processing unit to perform the steps of presenting to the trainee via the first audio-video component the first query in response to detecting the presence of the trainee at the first geographic location that is within the specified spatial proximity to the first audio-video component, and presenting to the trainee, via the one of the first audio-video component and the second audio-video component that is within the specified spatial proximity the second query in response to detecting the presence of the trainee at the second geographic location that is different from the first geographic location and within the specified spatial proximity to the one of the first audio-video component and the second audio-video component.

3. The method of claim 1, further comprising:
in response to the detecting the presence of the trainee at the first geographic location and within the specified spatial proximity to the first audio-video component, searching a plurality of different portions of training information that are stored in a storage medium for an unlearned portion;
returning the first unlearned portion in satisfaction of the search for the unlearned portion;
saving an indication to the storage medium that the first unlearned portion is learned in response to determining that a response by the trainee to the presented first query satisfies the presented first query;
in response to the detecting the presence of the trainee at the second geographic location and within the specified spatial proximity to the one of the first audio-video component and the second audio-video component, searching the plurality of different portions of training information that are stored in the storage medium for another unlearned portion; and
returning the second unlearned portion in satisfaction of the search for the another unlearned portion by excluding the first portion in response to the saved indication that the first unlearned portion is learned.

4. The method of claim 1, wherein the step of searching the plurality of different portions of training information stored in the storage medium for the unlearned portion is further in response to correlating a presentation schedule with a time of the detecting the presence of the trainee within the specified spatial proximity to the first audio-video component at the first geographic location.

5. The method of claim 4, wherein the step of searching the plurality of different portions of training information stored in the storage medium for the unlearned portion is further in response to the time of the detecting the presence of the trainee within the specified spatial proximity to the first audio-video component at the first geographic location not exceeding a specified deadline time.

6. The method of claim 5, further comprising:
updating a query history of the trainee in response to evaluating whether a response by the trainee to the presented first query satisfies the presented first query;
determining a proficiency score for the trainee as a function of the updated trainee query history; and
wherein the step of searching the plurality of different portions of training information that are stored in the storage medium for the another portion is further in response to the determined proficiency score failing to meet a specified proficiency threshold.

7. The method of claim 5, wherein the step of searching the plurality of different portions of training information stored in the storage medium for the unlearned portion is further in response to the time of the detecting the presence of the trainee within the specified spatial proximity to the first audio-video component at the first geographic location being within a work day defined within the presentation schedule.

8. The method of claim 5, wherein the first geographic location is a minor comprising the first audio-video component, and the second geographic location is a building lobby and the second audio-video component is a video display monitor located next to an elevator door.

9. A system, comprising:
a processing unit in communication with a computer readable memory and a tangible computer-readable storage medium;
wherein the processing unit, when executing program instructions stored on the tangible computer-readable storage medium via the computer readable memory:
in response to detecting a presence of a trainee at a first geographic location that is within a specified spatial proximity to a first audio-video component, presents to the trainee via the first audio-video component a first query that is associated with a first unlearned portion of a plurality of different stored portions of training information; and
in response to detecting a presence of the trainee at a second geographic location that is different from the first geographic location and within the specified spatial proximity to one of the first audio-video component and a second audio-video component, presents to the trainee, via the one of the first audio-video component and the second audio-video component that is within the specified spatial proximity a second query that is associated with a second portion of the plurality of different stored portions of training information that is different from the first unlearned portion; and
wherein the specified spatial proximity is selected so that:
text messages displayed in a specified font size on a display device of the one of the first audio-video component and the second audio-video component that is legible to the trainee within the specified spatial proximity to the display device;
a speaker of the one of the first audio-video component and the second audio-video component is near enough to the trainee to convey spoken words within audio media at an audio volume sufficiently loud to be heard and understood by the trainee, or
an earpiece worn by the trainee establishes a wireless communication with the one of the first audio-video component and the second audio-video component to convey the spoken words within the audio media; and
wherein the first query and the second query each comprise at least one of a text message displayed in the specified font size on the display device, and spoken words that are within the audio media.

10. The system of claim 9, wherein the processing unit, when executing the program instructions stored on the computer-readable storage medium via the computer readable memory, further:
in response to detecting the presence of the trainee at the first geographic location and within the specified spatial proximity to the first audio-video component, searches a plurality of different portions of training information that are stored in a storage medium for an unlearned portion;
returns the first unlearned portion in satisfaction of the search for the unlearned portion;
saves an indication to the storage medium that the first unlearned portion is learned in response to determining that a response by the trainee to the presented first query satisfies the presented first query;
in response to detecting the presence of the trainee at the second geographic location and within the specified spatial proximity to the one of the first audio-video component and the second audio-video component, searches the plurality of different portions of training information that are stored in the storage medium for another unlearned portion; and
returns the second unlearned portion in satisfaction of the search for the another unlearned portion by excluding the first portion in response to the saved indication that the first unlearned portion is learned.

11. The system of claim 9, wherein the processing unit, when executing the program instructions stored on the computer-readable storage medium via the computer readable memory, further searches the plurality of different portions of training information stored in the storage medium for the unlearned portion in response to a correlation of a presentation schedule with the time of detecting the presence of the trainee within the specified spatial proximity to the first audio-video component at the first geographic location.

12. The system of claim 11, wherein the processing unit, when executing the program instructions stored on the computer-readable storage medium via the computer readable memory, further searches the plurality of different portions of training information stored in the storage medium for the unlearned portion in response to the time of the detecting the presence of the trainee within the specified spatial proximity to the first audio-video component at the first geographic location not exceeding a specified deadline time.

13. The system of claim 12, wherein the processing unit, when executing the program instructions stored on the computer-readable storage medium via the computer readable memory, further:
updates a query history of the trainee in response to evaluating whether a response by the trainee to the presented first query satisfies the presented first query;
determines a proficiency score for the trainee as a function of the updated trainee query history; and
searches the plurality of different portions of training information that are stored in the storage medium for the another portion in response to the determined proficiency score failing to meet a specified proficiency threshold.

14. The system of claim 12, wherein the processing unit, when executing the program instructions stored on the computer-readable storage medium via the computer readable memory, searches the plurality of different portions of training information stored in the storage medium for the unlearned portion in response to the time of the detecting the presence of the trainee within the specified spatial proximity to the first audio-video component at the first geographic location being within a work day defined within the presentation schedule.

15. A computer program product for pervasive training across multiple devices or locations, the computer program product comprising:
a computer readable tangible storage medium having computer readable program code embodied therewith, the computer readable program code comprising instructions that, when executed by a computer processing unit, cause the computer processing unit to:
in response to detecting a presence of a trainee at a first geographic location that is within a specified spatial proximity to a first audio-video component, present to the trainee via the first audio-video component a first query that is associated with a first unlearned portion of a plurality of different stored portions of training information; and
in response to detecting a presence of the trainee at a second geographic location that is different from the first geographic location and within the specified spatial proximity to one of the first audio-video component and a second audio-video component, present to the trainee, via the one of the first audio-video component and the second audio-video component that is within the specified spatial proximity a second query that is associated with a second portion of the plurality of different stored portions of training information that is different from the first unlearned portion; and
wherein the specified spatial proximity is selected so that:
text messages displayed in a specified font size on a display device of the one of the first audio-video component and the second audio-video component that is legible to the trainee within the specified spatial proximity to the display device;
a speaker of the one of the first audio-video component and the second audio-video component is near enough to the trainee to convey spoken words within audio media at an audio volume sufficiently loud to be heard and understood by the trainee, or
an earpiece worn by the trainee establishes a wireless communication with the one of the first audio-video component and the second audio-video component to convey the spoken words within the audio media; and
wherein the first query and the second query each comprise at least one of a text message displayed in the specified font size on the display device, and spoken words that are within the audio media.

16. The computer program product of claim 15, wherein the computer readable program code instructions, when executed by the computer processing unit, further cause the computer processing unit to:
in response to detecting the presence of the trainee at the first geographic location and within the specified spatial proximity to the first audio-video component, search a plurality of different portions of training information that are stored in a storage medium for an unlearned portion;
return the first unlearned portion in satisfaction of the search for the unlearned portion;
save an indication to the storage medium that the first unlearned portion is learned in response to determining that a response by the trainee to the presented first query satisfies the presented first query;
in response to detecting the presence of the trainee at the second geographic location and within the specified spatial proximity to the one of the first audio-video component and the second audio-video component, search the plurality of different portions of training information that are stored in the storage medium for another unlearned portion; and
return the second unlearned portion in satisfaction of the search for the another unlearned portion by excluding the first portion in response to the saved indication that the first unlearned portion is learned.

17. The computer program product of claim 15, wherein the computer readable program code instructions, when executed by the computer processing unit, further cause the computer processing unit to search the plurality of different portions of training information stored in the storage medium for the unlearned portion in response to a correlation of a presentation schedule with the time of detecting the presence of the trainee within the specified spatial proximity to the first audio-video component at the first geographic location.

18. The computer program product of claim 17, wherein the computer readable program code instructions, when executed by the computer processing unit, further cause the computer processing unit to search the plurality of different portions of training information stored in the storage medium for the unlearned portion in response to the time of the detecting the presence of the trainee within the specified spatial proximity to the first audio-video component at the first geographic location not exceeding a specified deadline time.

19. The computer program product of claim 18, wherein the computer readable program code instructions, when executed by the computer processing unit, further cause the computer processing unit to:
update a query history of the trainee in response to evaluating whether a response by the trainee to the presented first query satisfies the presented first query;
determine a proficiency score for the trainee as a function of the updated trainee query history; and
search the plurality of different portions of training information that are stored in the storage medium for the another portion in response to the determined proficiency score failing to meet a specified proficiency threshold.

20. The computer program product of claim 18, wherein the computer readable program code instructions, when executed by the computer processing unit, further cause the computer processing unit to search the plurality of different portions of training information stored in the storage medium for the unlearned portion in response to the time of the detecting the presence of the trainee within the specified spatial proximity to the first audio-video component at the first geographic location being within a work day defined within the presentation schedule.
